(19) United States
(12) Patent Application Publication
(10) Pub. No.: US 2025/0322986 A1
(43) Pub. Date: Oct. 16, 2025

(54) INDUCTIVE COMPONENT

(71) Applicant: WÜRTH ELEKTRONIK EISOS GMBH & CO. KG, Waldenburg (DE)

(72) Inventors: Thomas BRANDER, Kupferzell (DE); Simon MARK, Lippstadt (DE)

(21) Appl. No.: 18/864,418

(22) PCT Filed: May 10, 2023
(86) PCT No.: PCT/EP2023/062360

§ 371 Date: Nov. 8, 2024

(30) Foreign Application Priority Data
May 11, 2022 (DE) 10 2022 204 625.0

(51) Int. Cl. H01F 27/28; H01F 3/14; H01F 27/24

(52) U.S. Cl. CPC H01F 27/2823; H01F 3/14; H01F 27/24

(57) ABSTRACT

An inductive component for high-current applications is described. The inductive component comprises a core and a conductor with a winding section arranged circumferentially around the core. The winding section extends circumferentially around the core along a circular arc with a center point angle b, where: 45°≤b<360°.

The content of the German Patent Application DE 10 2022 204 625.0 is incorporated by reference herein.

The invention relates to an inductive component for high-current applications, in particular in the medium-frequency range.

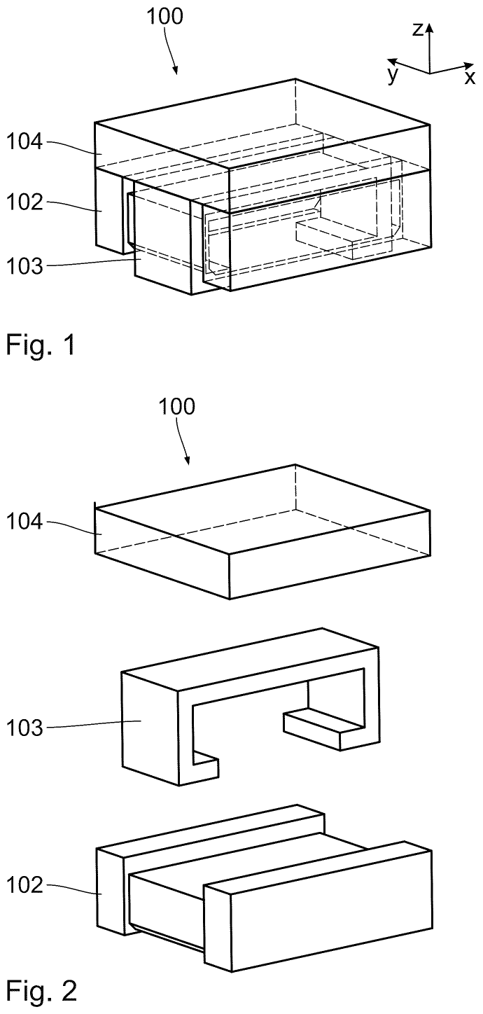

Inductive components for high-current applications are known. In order to reduce the self-inductance at high currents, inductive components of this kind generally have a low inductance, for example in the nanohenry or low microhenry range. FIGS. 1 and 2 show an inductor for high-current applications that is already known. An inductor 100 has a substantially cuboidal core plate 102. The core plate 102 is surrounded on three sides by a conductor bracket 103 bent in a rectangular shape. A covering plate 104 is fitted onto the core plate 102 and the conductor bracket 103 arranged on it.

The object of the present invention is to improve an inductive component for high-current applications, in particular to improve the electromagnetic properties of the inductive component.

This object is achieved by an inductive component having the features cited in claim 1. The inductive component has a core and a conductor with a winding section arranged circumferentially around the core. The winding section extends circumferentially around the core along a circular arc with a center point angle b, where: 45°≤b<360°. The center point angle b<360° means that the winding section does not extend around the entire circumference of the core. The winding section does not form a complete winding. This is advantageous for high-current applications. The extent of the winding section along the circular arc leads to the length of the winding section per unit of enclosed volume being reduced, in particular in relation to conductors bent in a rectangular shape. The reduction in the length of the winding section leads to a saving in material and to a reduced DC resistance. Line losses and undesired development of heat are reduced. The inductive component has improved electrical and mechanical properties. The inductive component is also referred to as an inductor or high-current inductor in the text which follows.

The inductive component is designed for high-current applications, in particular in the medium-frequency range. Here, high-current applications should be understood to mean, in particular, applications with a current flow of at least 10 A, in particular at least 15 A, in particular at least 20 A. The inductive component is designed, in particular, for currents in the range of from 10 A to 125 A, in particular of from 15 A to 125 A, in particular of from 20 A to 125 A. The medium-frequency range contains, in particular, frequencies of from 100 kHz to 1 MHz, in particular of from 250 kHz to 750 kHz, for example of approximately 500 kHz. Frequencies in these ranges are also referred to as medium frequencies or radiofrequencies. The inductive component is preferably designed for operation in these frequency ranges.

The extent of the winding section along the circular arc should be understood, in particular, in such a way that the winding section runs approximately in the form of a circular arc in the circumferential direction. For example, the winding section can be bent in the form of an arc, in particular in the form of a circular arc. However, an extension along the circular arc within the meaning of the invention also includes other profiles of the winding section that are approximately in the form of an arc, in particular in the form of a circular arc. For example, a polygonal profile of the winding section can also approximate the circular arc. For example, the coil former can run along the contour of a polygon with n corners, where n is at least 5, in particular at least 6, preferably greater than 6. The winding section has, for example, at least 3 corners for each 180° center point angle. In comparison to a rectangular conductor bracket, the length of the winding section per unit of enclosed volume is significantly reduced in this way.

The winding section preferably extends along the circular arc in such a way that the entire area of a segment of a circle surrounded by the circular arc is enclosed by the winding section.

The winding section can have, in particular, a length which differs at most by 20%, in particular at most by 10%, in particular at most by 5%, from the length of the circular arc in the circumferential direction.

The advantages of the winding section extending along the circular arc are independent of the size of the inductive component, in particular independent of a radius of the circular arc. In particularly suitable inductive components, the circular arc can have a radius of between 1 mm und 5 mm, in particular of between 1 mm and 2.3 mm, in particular of between 1.5 mm and 2.1 mm. The radius can be, for example, approximately 2.05 mm.

The conductor can consist substantially of the winding section. The conductor can have additional conductor sections adjoining the winding section. For example, the conductor can have electrodes for making contact with the winding section. For example, the electrodes can be formed by extensions of the winding section. The electrodes can also be connected to the winding section at end sides of the winding section.

The conductor, in particular the winding section and/or the electrodes, preferably contains/contain a metal of high conductivity. For example, the conductor can consist of copper.

The core can be in the shape of a general cylinder, in particular in a core section circumferentially surrounded by the winding section. A core section circumferentially surrounded by the winding section is also referred to as a coil former in the text which follows. A cylinder axis of the core, in particular of the coil former, can be, in particular, perpendicular to a plane in which the circular arc along which the winding section extends runs. The cylinder axis can run, for example, through a center point corresponding to the circular arc. A base area of the core, in particular of the coil former, can lie in the plane of the circular arc, for example. The base area of the core, in particular of the coil former, can correspond, for example, to a contour of the winding section in the plane of the circular arc. The base area can preferably be substantially in the shape of a segment of a circle surrounded by the circular arc.

The core is magnetic in particular. The core preferably consists of a ferrite, in particular of a soft-magnetic ferrite. Suitable ferrites are, in particular, manganese-zinc ferrites and/or nickel-zinc ferrites.

A center point angle as claimed in claim 2 has proven particularly suitable. The center point angle b is preferably approximately 180°. The winding section forms, in particular, a semi-arcuate winding. This allows a compact design together with a large enclosed volume. A base area of the core, in particular of the coil former, is semicircular in particular.

An inductive component as claimed in claim 3 ensures improved mechanical, magnetic and/or electrical properties. An arcuate, in particular circularly arcuate, embodiment of the winding section can be manufactured in a stable and simple manner and has a particularly expedient ratio between enclosed volume and length of the winding section. For example, the winding section can be bent around the core approximately in the form of a circular arc. A curvature of the winding section in the form of an arc preferably deviates from the curvature of the circular arc at most by 20%, in particular at most by 15%, in particular at most by 10%. Bends in the conductor are avoided. The winding section is preferably embodied as a circular arc, for example as a quarter arc, a half arc or a three-quarter arc. The winding section is particularly preferably embodied as a half arc.

An inductive component as claimed in claim 4 ensures improved mechanical and/or electrical properties. The flat wire or bracket can be shaped, in particular bent, in a simple manner into the shape corresponding to the extent along the circular arc. The resulting winding section is stable. In addition, a flat wire or bracket is particularly suitable for high currents.

The conductor preferably has a rectangular cross section with a broad side and a narrow side in the winding section. An exemplary width of the broad side can be between 1 mm and 5 mm, for example approximately 2.5 mm. A thickness of the conductor along the narrow side can be, for example, between 0.1 mm and 1 mm, in particular approximately 0.5 mm.

An inductive component as claimed in claim 5 ensures improved mechanical, magnetic and/or electrical properties. The broad side of the conductor can be, in particular, parallel to a cylinder axis of the core, in particular of the coil former. The broad side preferably runs along a lateral surface of the core. A corresponding arrangement of the conductor allows simple manufacture, in particular simple bending of the winding section around the core. The conductor, by way of its entire broad side, contributes to the volume enclosed by the current flow. This allows a particularly large magnetically active volume with given dimensions, in particular with a given length, of the conductor.

An inductive component as claimed in claim 6 has a compact design and a high inductance per unit of volume. It has been found that the magnetic flux runs substantially within the segment of a circle corresponding to the circular arc. Regions of the core outside the segment of a circle therefore make hardly any contribution to the magnetic properties of the inductive component. Since the cross section of the core lies completely within the segment of a circle, it is possible to save core material, without the magnetic properties of the core, in particular the magnetic flux within the core, being disadvantageously affected. The inductor is compact and has a low weight. The inductor can additionally be manufactured in a cost-effective manner. The inductance per unit of volume is improved.

A segment of a circle corresponding to the circular arc should be understood in such a way that the circular arc encloses the segment of a circle. In particular, the segment of a circle has the same radius, the same center point and the same center point angle as the circular arc. Given a center point angle b of 180°, the segment of a circle is, for example, a semicircle.

The cross section of the core is defined, in particular, in the plane of the circular arc. The cross section of the core can be defined, for example, perpendicular to a cylinder axis of the core. The cross section of the core corresponds, in particular, to a base area of the core, in particular of the coil former.

An inductive component as claimed in claim 7 ensures particularly good magnetic and/or mechanical properties. As high as possible coverage of the segment of a circle by the core cross section largely utilizes the region surrounded by the winding section. The core, in particular the coil former, has a large cross-sectional area for the magnetic flux together with a compact design. The core cross section preferably substantially fills the segment of a circle. The inductive component has a high inductance together with a compact design. The inductance per unit of volume is increased.

The core cross section particularly preferably substantially has a cross-sectional area corresponding to the segment of a circle. The cross-sectional area of the core, in particular a base area of the coil former, can be substantially semicircular.

An inductive component as claimed in claim 8 has particularly advantageous magnetic and/or mechanical properties. It has been found that the magnetic flux in the region of the center point of the circular arc is low. Owing to the cutout in the region of the center point, it is therefore possible to save core material, without the magnetic properties of the core being substantially adversely affected. The inductance per unit of volume is further increased. Less core material leads to a lower weight and lower manufacturing costs for the inductive component.

The cutout can, in particular, be in the form of a segment of a circle. A center point angle cutout preferably corresponds to the angle b. A radius of the cutout is, in particular, smaller than a radius of the circular arc along which the winding section extends. A radius of the cutout is, in particular, smaller than a radius of the circular arc along which the winding section extends. A ratio of the radius of the cutout to the radius of the circular arc along which the winding section extends is, for example, between 0.1 and 0.6, in particular between 0.15 and 0.5, in particular between 0.2 and 0.4, for example approximately 0.25. The cutout can be semicircular, in particular.

The inductor particularly preferably has an inductance per unit of volume of at least 0.65 nH/mm³, in particular at least 0.70 nH/mm³, in particular at least 0.75 nH/mm³.

An inductive component as claimed in claim 9 has particularly advantageous mechanical and/or magnetic properties. The core preferably has a flange at each of the mutually opposite ends. The at least one flange adjoins the coil former in particular in the direction of a cylinder axis. The at least one flange preferably has a larger cross section than the coil former. The at least one flange particularly preferably projects beyond a cross section of the coil former in the radial direction in an angular region in which the coil former extends along a circular arc. The at least one flange preferably has the same cross-sectional contour as a core section which is circumferentially surrounded by the winding section. For example, the at least one flange has a cross section in the form of a segment of a circle, in particular a semicircular cross section. The at least one flange increases the core volume.

The winding section can particularly preferably be arranged between two flanges arranged at the ends. This leads to a stable arrangement of the winding section. The end-side flanges shield the conductor.

An inductive component as claimed in claim 10 exhibits high stability and good electromagnetic shielding. The conductor is shielded by the outer core around the circumference of the winding section. The outer core additionally leads to a stable arrangement of the winding section between the core and the outer core. The core volume for the magnetic flux is additionally increased by the outer core. This improves the magnetic properties, in particular the inductance is increased.

An inductive component as claimed in claim 11 has a compact design. An outer core in the form of an arc, in particular in the form of a circular arc, in the circumferential direction of the core is optimally matched to the winding section extending along the circular arc, in particular to a winding section in the form of an arc, in particular in the form of a circular arc. A cross section of the outer core efficiently covers the regions of high magnetic flux.

The outer core surrounds the winding section, in particular in the form of part of a ring. A ring subregion covered by the outer core corresponds, in particular, to the center point angle b. A thickness of the outer core in the radial direction is, for example, between 0.3 mm and 2 mm, in particular between 0.5 mm and 1 mm, for example approximately 0.7 mm.

An inductive component as claimed in claim 12 exhibits high stability and good shielding of the conductor. Owing to the arrangement of the winding section in the groove, the winding section is also shielded at the end sides. The winding section is held in the groove in a stable and reliable manner.

The groove preferably has a cross section which corresponds to the cross section of the conductor in the winding section, in particular to the cross section of the flat wire or bracket used.

An inductive component as claimed in claim 13 ensures improved magnetic and/or mechanical properties. The core, the winding section and the outer core can be easily positioned in relation to each other owing to the air gap. Manufacturing inaccuracies can be compensated for. The air gap additionally increases the magnetic saturation of the inductive component.

In particular, it is possible for the air gap to form a receiving space for the winding section. The winding section is arranged between the core and the outer core in a secure and stable a manner.

An inductive component as claimed in claim 14 ensures improved magnetic and/or mechanical properties. The various core pieces can be easily positioned in relation to each other. In particular, assembly of the inductive component is simplified, for example by way of the core pieces being able to be pushed into a recess in the outer core from different sides. This is particularly advantageous for cores with flanges arranged at the ends.

Different core pieces are preferably separated from each other along a cylinder axis of the core. The different core pieces can form various core sections along the cylinder axis. For example, two core pieces can form two halves of the core. The core pieces are, in particular, symmetrical in relation to each other. The core pieces can be identical, for example.

An inductive component as claimed in claim 15 ensures improved magnetic and/or mechanical properties. The design of the core air gap increases the magnetic saturation. A relative arrangement of the core pieces is simplified on account of the air gap.

The inductive component can preferably have an air gap between an outer core and the core and/or a core air gap between various core pieces. Owing to the variation in the air gap and/or core air gap, magnetic properties and/or electrical properties, for example magnetic saturation and/or saturation current, can be influenced in particular. An exemplary size of the air gap and/or of the core air gap is, in particular, between 0.03 mm and 0.15 mm, in particular between 0.03 mm and 0.065 mm.

Further features, advantages and details of the invention can be found in the following description of a plurality of exemplary embodiments. In the drawings:

FIG. 1 shows a perspective view of a high-current inductor from the prior art,

FIG. 2 shows an exploded illustration of the high-current inductor according to FIG. 1,

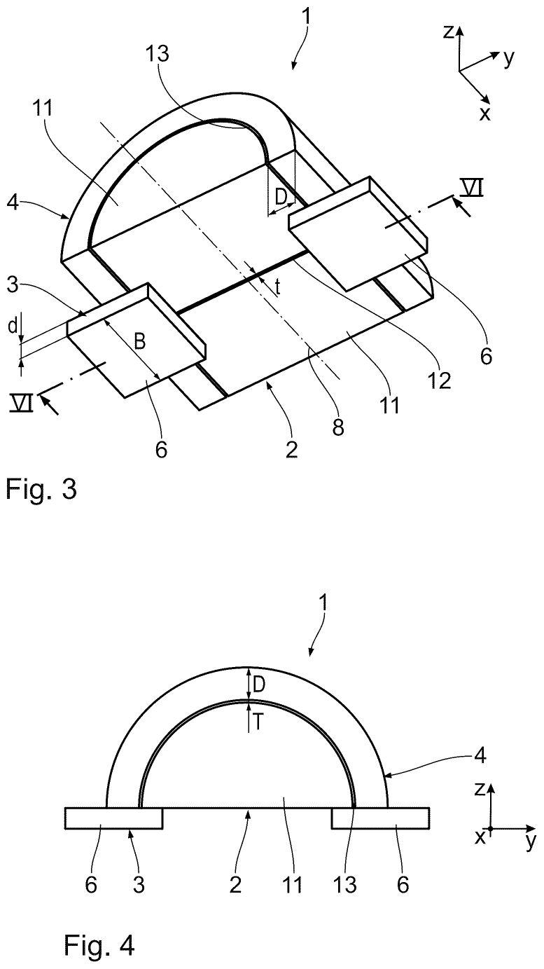

FIG. 3 shows a perspective view of an inductive component according to a first exemplary embodiment,

FIG. 4 shows a front-end view of the inductive component according to FIG. 3,

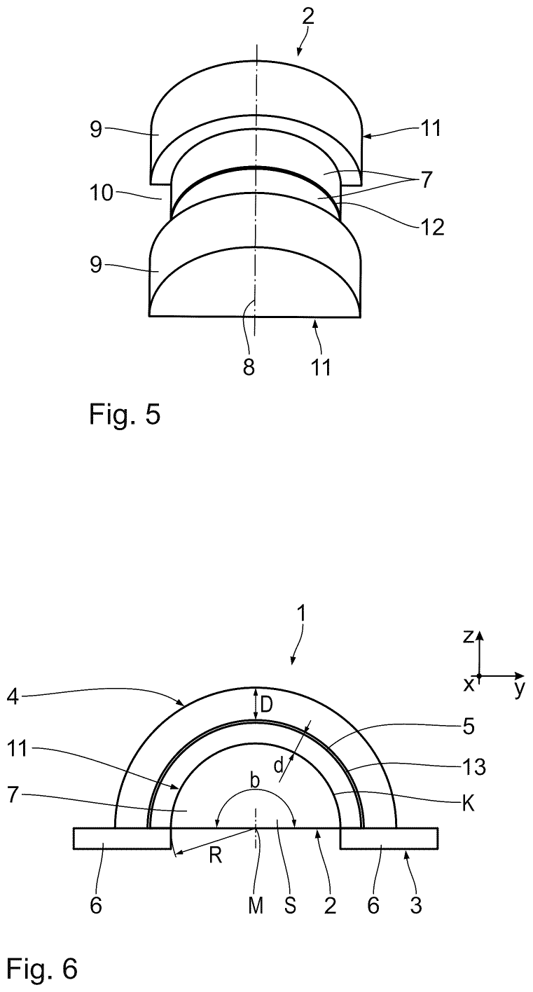

FIG. 5 shows a perspective view of a core of the inductive component according to FIG. 3,

FIG. 6 shows a cross section through the inductive component according to FIG. 3 along a sectional plane VI-VI,

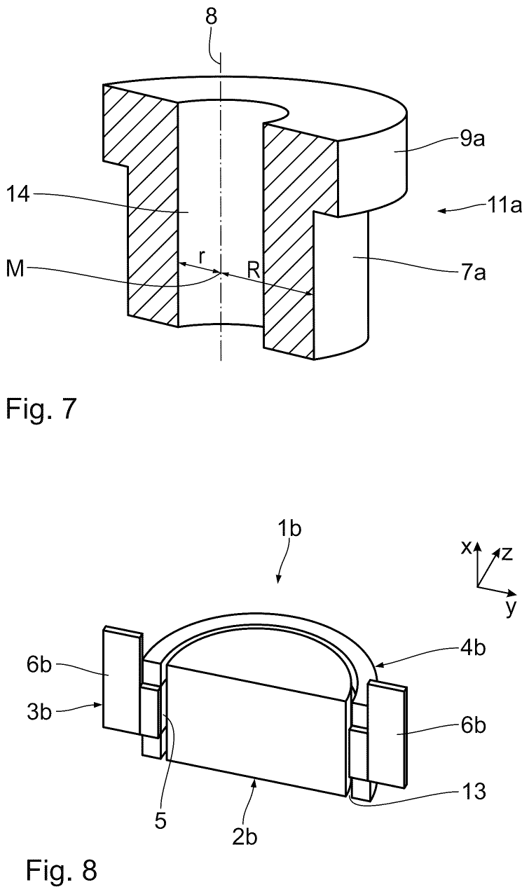

FIG. 7 shows a perspective view of a core piece of a core of an inductive component according to a further exemplary embodiment,

FIG. 8 shows a perspective view of an inductive component according to a further exemplary embodiment,

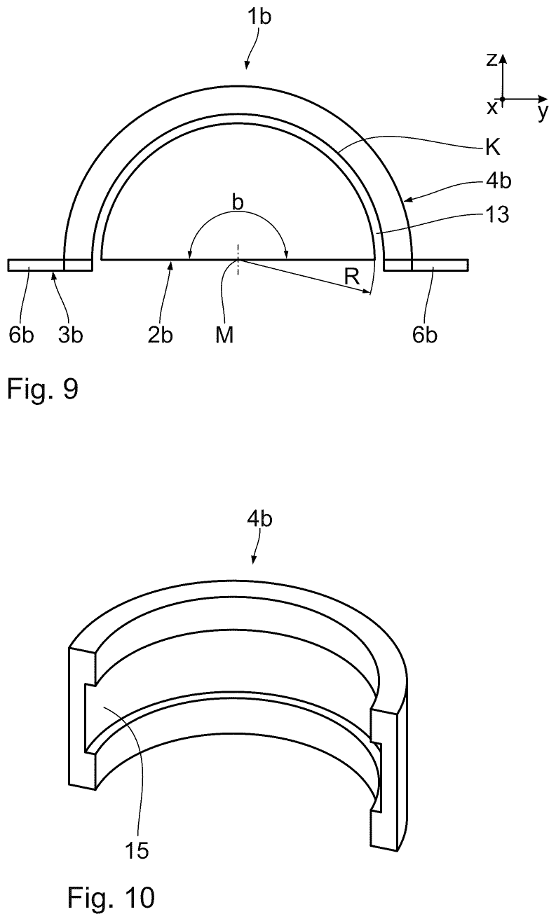

FIG. 9 shows a front-end view of the inductive component according to FIG. 8,

FIG. 10 shows a perspective view of an outer core of the inductive component according to FIG. 8,

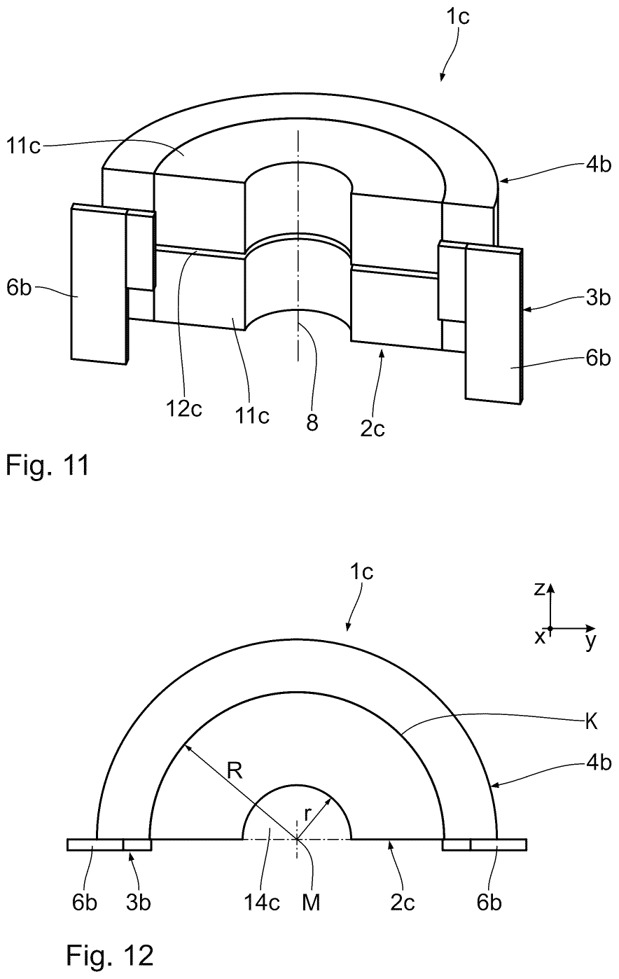

FIG. 11 shows a perspective view of an inductive component according to a further exemplary embodiment,

FIG. 12 shows a front-end view of the inductive component according to FIG. 11,

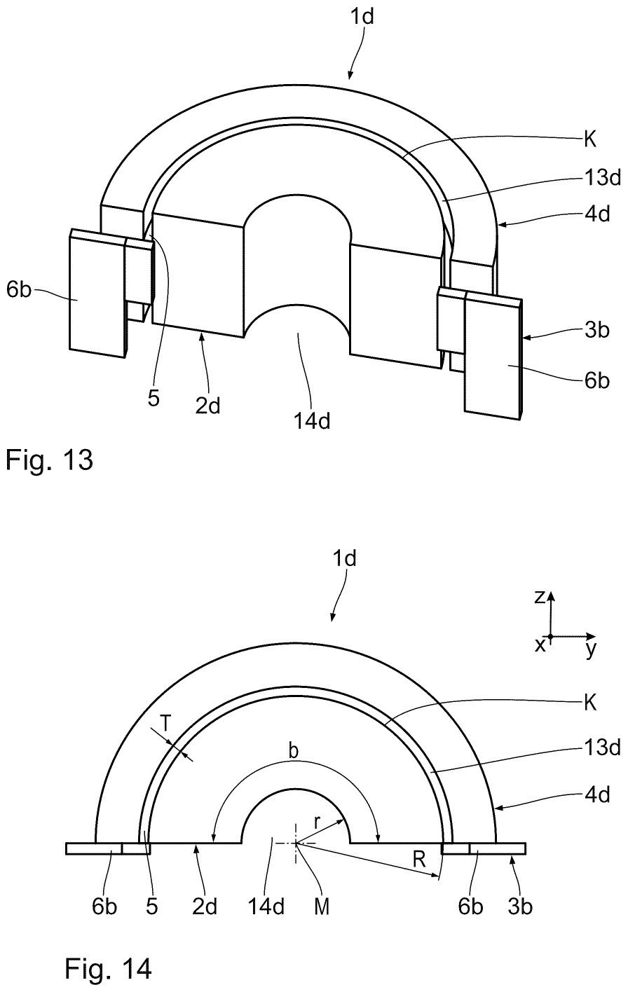

FIG. 13 shows a perspective view of an inductive component according to a further exemplary embodiment, and

FIG. 14 shows a front-end view of the inductive component according to FIG. 13.

A first exemplary embodiment of an inductive component for high-current applications in the form of an inductor 1 is shown with reference to FIGS. 3 to 6. The inductor 1 has a core 2, a conductor 3 and an outer core 4. The components of the inductor 1 are described with reference to the orthogonal coordinate system with the axes x, y and z shown in the figures.

The core 2 and the outer core 4 are manufactured, for example, from soft-magnetic ferrites, in particular manganese-zinc ferrite and/or nickel-zinc ferrite. The conductor 3 consists of a conductive metal, in particular of copper.

The conductor 3 has a winding section 5 arranged circumferentially around the core 2. At the end sides of the winding section 5, the conductor 3 has two electrodes 6 for making contact with the winding section 5. The conductor 3 comprises a flat wire forming the winding section 5. The electrodes 6 are embodied as wire extensions of the flat wire. The flat wire has a broad side with the width B running parallel to the x-direction. The broad side of the flat wire faces the core 2. Perpendicular to the broad side, the flat wire has a narrow side with the thickness d.

The core 2 has a core section in the form of a coil former 7 circumferentially surrounded by the winding section 5. The coil former 7 is in the form of a general cylinder. A cylinder axis 8 of the coil former 7 extends along the x-axis. The core 2 has a length L in the direction of the cylinder axis 8. A base area of the cylinder lies in the z-y plane. The base area of the coil former 7 is semicircular. The base area of the coil former 7 corresponds to a segment of a circle with a center point angle b and a radius R. The center point angle b is 180° in the exemplary embodiment shown.

A flange 9 of the core 2 adjoins each of the end sides of the coil former 7 in the direction of the cylinder axis 8. The flanges 9 have the same cross-sectional shape as the coil former 7 perpendicular to the cylinder axis 8. The cross section of the flanges 9 perpendicular to the cylinder axis 8 is semicircular. The radius of the cross section of the flanges 9 is substantially increased in size by a thickness d of the narrow side of the flat wire forming the winding section 5. A length of the coil former 7 in the direction of the cylinder axis 8 corresponds substantially to a width B of the broad side of the flat wire forming the winding section 5. A groove-like receiving space 10 for the winding section 5 of the conductor 3 is formed by the smaller cross-sectional radius of the coil former 7.

The core 2 has two core pieces 11. The core 2 is in two parts. The core pieces 11 lie opposite each other in the direction of the cylinder axis 8. The core pieces 11 are spaced apart from each other in the direction of the cylinder axis 8. A core air gap 12 is formed between the core pieces 11. The core air gap 12 has a gap size t in the direction of the cylinder axis 8. The core air gap 12 is formed centrally in the core 2 with respect to the cylinder axis 8.

The core pieces 11 exhibit mirror-image symmetry with respect to a mirror plane defined level with the core air gap 12 in the y-z plane. The core pieces 11 form two core halves. Each core piece 11 has a portion of the coil former 7 and one of the flanges 9.

The winding section 5 of the conductor 3 is arranged circumferentially around the coil former 7 of the core 2. The winding section 5 is arranged in the groove-like receiving space 10 between the flanges 9. The winding section 5 extends along a circular arc K with the center point angle b. The winding section 5 forms half a winding of the conductor 3. In the exemplary embodiment shown, the winding section is in the form of a circular arc. The winding section 5 runs along the circular arc K in the circumferential direction of the core 2. The winding section 5 is semi-arcuate.

A broad side of the winding section 5 preferably bears against a lateral surface of the coil former 7.

The cross section of the core 2 defined perpendicular to the cylinder axis 8 in the region of the coil former 7 lies within a segment S of a circle corresponding to the circular arc K. In the present exemplary embodiment, the cross section of the core 2 in the region of the coil former 7 corresponds substantially to the segment S of a circle. The cross section of the core 2 in the region of the coil former 7 substantially completely fills the segment S of a circle.

The outer core 4 circumferentially surrounds the core 2 and the winding section 5 of the conductor 3. The outer core 4 is in the form of a circular arc in the circumferential direction of the core 2. The outer core 4 covers a circular arc with a center point angle b.

The outer core 4 is spaced apart from the core 2 and the winding section 5 by an air gap 13 running circumferentially around the core 2. The air gap 13 has a gap size T.

The outer core 4 is in the form of a general cylinder, the cylinder axis of which runs parallel to the cylinder axis 8 in the x-direction. The outer core 2 covers the entire length L of the core 2 in the direction of the cylinder axis 8.

The base area of the outer core 4 is perpendicular to the x-direction in the y-z plane. The base area is in the form of a partial circular ring with a center point angle b and a ring width D. An inner radius of the partial circular ring corresponds substantially to the sum of the radius R of the circular arc K, the thickness d of the flat wire and the gap size T of the air gap 13.

The extent of the winding section 5 along the circular arc K has the advantage that a greater volume is enclosed per unit of length of the winding section 5. As a result, the length of the winding section 5 can be reduced given the same inductance. As a result, the winding section 5 has a lower DC resistance.

The cross section of the core 2 lying within the segment S of a circle has the advantage that the core volume is reduced in comparison to a circular-cylindrical core. As a result, the inductance per unit of volume of the inductor is increased.

The winding section 5 is reliably shielded by the flanges 9 and the outer core 4.

The advantages of the inductor 1 are independent of the specific dimensions of its components. In comparison to the inductor already known from FIGS. 1 and 2, the inductor 1 has a volume that is approximately 27% lower given the same maximum extent in the x-, y- and z-direction. The inductance per unit of volume is considerably increased given a comparable inductance. The consumption of material and the weight and the manufacturing costs of the inductor 1 are reduced.

For example, the already known inductor 100 has a volume of 122 mm³ given a length in the x-direction of 6 mm, an extent in the y-direction of 6.8 mm and an extent in the z-direction of 3.4 mm. The inductor 1 has a volume of approximately 88 mm³ given corresponding maximum dimensions in the x-, y-and z-direction.

A further advantage of the inductor 1 is that its dimensions, in particular the radius R of the circular arc K, the center point angle b, the width B of the conductor 3, the thickness d of the conductor 3, the ring width D of the outer core 4, the length L, the gap size t of the core air gap 12 and/or the gap size T of the air gap 13 can be varied substantially independently of each other. The inductor 1 can be flexibly adapted to the respective requirements.

A further exemplary embodiment of an inductor is described with reference to FIG. 7. Components that have already been described in conjunction with the exemplary embodiment in FIGS. 3 to 6 are provided with the same reference signs. Structurally different but functionally identical components are provided with the same reference signs followed by the letter a.

The inductor differs from the inductor shown in FIGS. 3 to 6 only in terms of the configuration of the core. FIG. 7 shows a core piece 11a of the core. The core piece 11a has a flange 9a and a tapered portion for forming a coil former 7a. The core piece 11a has a cutout 14 formed around the center point M. Perpendicular to the cylinder axis 8, the cutout 14 has a semicircular cross section around the center point M with a radius r.

It has been found that the magnetic flux in a cross-sectional region surrounding the center point M is low. Therefore, owing to the cutout 14, further core material can be saved, without adversely affecting the magnetic flux within the core. A core composed of core pieces 11a therefore allows a further increase in the inductance per unit of volume.

In comparison to the exemplary embodiment shown in FIGS. 3 to 6, the tapering part of the core piece 11a that forms the coil former 7a has a greater length in the direction of the cylinder axis 8. This allows a flat wire with a greater width B to be fitted onto the core. As an alternative, it is also possible for the flat wire to have a lower width B than the length of the coil former 7a in the direction of the cylinder axis. The core volume can be adjusted independently of the width of the winding section.

FIGS. 8 to 10 show a further exemplary embodiment of an inductive component in the form of an inductor 1b. Components that have already been described in conjunction with the exemplary embodiments in FIGS. 3 to 7 are provided with the same reference signs. Structurally different but functionally identical components are provided with the same reference signs followed by the letter b.

The inductor 1b has a conductor 3b, the electrodes 6b of which are widened in comparison to the flat wire forming the winding section 5. This simplifies connection and contacting of the electrodes 6b.

A groove 15 is made on the inner side of the outer core 4b facing the core 2b. The groove 15 serves to receive the winding section 5 of the conductor 3b. The winding section 5 is arranged in the groove 15.

The core 2b is formed in one piece. The core 2b does not have any core air gap between various core pieces. The core 2b is particularly stable and structurally simple.

The core 2b has a semicircular cross section in the y-z plane. The cross section is constant along the cylinder axis 8. The core 2b has a simple design.

FIGS. 11 und 12 show a further exemplary embodiment of an inductive component in the form of an inductor 1c. Components that have already been described in conjunction with the exemplary embodiments in FIGS. 3 to 10 are provided with the same reference signs. Structurally different but functionally identical components are provided with the same reference signs followed by the letter c.

The inductor 1c differs from the inductor 1b described in FIGS. 8 to 10 only in terms of the configuration of the core 2c. The outer core 4b and the conductor 3b are identical. In particular, the winding section 5 of the conductor 3b is arranged within a groove 15 in the outer core 4b.

The core 2c has two core pieces 11c spaced apart in the direction of the cylinder axis 8. A core air gap 12c is formed between the core pieces 11c.

The core pieces 11c of the core 2c are identical. Perpendicular to the cylinder axis 8, the core pieces 11c have a cross section that is constant along the cylinder axis 8. The cross section of the core pieces 11c corresponds to the cross section of the core 2c. The cross section is in the form of a partial circular ring. A semicircular cutout 14c with a radius r is formed around the center point M. The radius r of the cutout 14c forms an inner radius of the cross section in the form of a partial circular ring. The outer radius of the cross section of the core 2c corresponds to the radius R of the circular arc K along which the winding section 5 runs. The core 2c, by way of its lateral surface, bears against the outer core 4b or against an inner side of the flat wire forming the winding section 5. There is no air gap formed between the outer core 4b and the core 2c.

FIGS. 13 und 14 show a further exemplary embodiment of an inductive component in the form of the inductor 1d. Components that have already been described with reference to the exemplary embodiments above are provided with the same reference signs. Structurally different but functionally identical components are provided with the same reference signs followed by the letter d.

The inductor 1d has a one-piece core 2d without a core air gap. The core 2d has a cross section in the form of a partial circular ring and with a center point angle b. A semicircular cutout 14 with a radius r is formed in the region of the center point M. The outer radius R of the cross section of the core 2d corresponds to the radius R of the circular arc K along which the winding section 5 of the conductor 3b runs. The winding section 5 bears against a lateral surface of the core 2d.

The outer core 4d has a cross section which is in the form of a partial circular ring and is constant along the cylinder axis.

An air gap 13d is formed between the core 2d and the outer core 4d. The air gap 13d has a gap size T which corresponds substantially to a thickness d of the flat wire forming the winding section 5.

1. An inductive component for high-current applications, comprising
a core and
a conductor with a winding section arranged circumferentially around the core,
wherein the winding section extends circumferentially around the core along a circular arc with a center point angle b, where: 45°≤b<360°.

2. The inductive component as claimed in claim 1, wherein for the center point angle b: 90°≤b<270°.

3. The inductive component as claimed in claim 1, wherein
the winding section is in the form of an arc.

4. The inductive component as claimed in claim 1, wherein
the winding section is formed from a flat wire or a bracket.

5. The inductive component as claimed in claim 4, wherein
the broad side of the flat wire or the bracket faces the core.

6. The inductive component as claimed in claim 1, wherein
a cross section of the core in a core section circumferentially surrounded by the winding section lies completely within a segment of a circle corresponding to the circular arc.

7. The inductive component as claimed in claim 1, wherein
a cross section of the core covers at least 55% of the area of a segment of a circle corresponding to the circular arc in a core section circumferentially surrounded by the winding section.

8. The inductive component as claimed in claim 1, wherein
a cross section of the core has a cutout in the region of a center point of the circular arc.

9. The inductive component as claimed in claim 1, wherein
the core has at least one flange arranged at the end sides.

10. The inductive component as claimed in claim 1, wherein
an outer core circumferentially surrounding the winding section of the conductor.

11. The inductive component as claimed in claim 10, wherein
the outer core is in the form of an arc.

12. The inductive component as claimed in claim 10, wherein
the winding section is arranged in a groove in the outer core.

13. The inductive component as claimed in claim 10, wherein
an air gap is formed between the core and the outer core.

14. The inductive component as claimed in claim 1, wherein
the core has a plurality of core pieces.

15. The inductive component as claimed in claim 14, wherein
a core air gap is formed between at least two core pieces.
